(19) United States
(12) Patent Application Publication
(10) Pub. No.: US 2012/0180675 A1
(43) Pub. Date: Jul. 19, 2012

(54) PRESS HAVING A DIRECT-DRIVEN CRANK DRIVE

(75) Inventor: Matthias Graf, Bretten (DE)

(73) Assignee: Dieffenbacher GmbH Maschinen-und Anlagenbau

(21) Appl. No.: 13/386,797

(22) PCT Filed: Jul. 27, 2010
(86) PCT No.: PCT/EP2010/004595

§ 371 Date: Apr. 6, 2012

(30) Foreign Application Priority Data
Jul. 29, 2009 (DE) 10 2009 035 215.5

(51) Int. Cl. B30B 1/26

(52) U.S. Cl. 100/282

(57) ABSTRACT

A press having at least one press frame, a table mounted therein and a tappet or ram driven by at least one crank drive for incorporating work tools or for producing work pieces by at least one production method in a tool, wherein a tool upper part is arranged on the ram and a tool lower part is arranged on the press table, wherein at least one crank shaft having at least one crank pin and at least one connecting rod is arranged as a crank drive and wherein at least one direct drive, directly driving the crank shaft, is arranged as a motor for the crank shaft drive, wherein the motor is arranged substantially adjacent to a crank pin on the crank shaft.

The invention relates to a press with a directly driven crank drive according to the preamble of claim 1.

Production machines with a reversing ram typically have a motor driven drive and a crank drive that converts the rotational motion of the drive into a linear and reversing motion. Usually such production systems are used as presses for forming or cutting workpieces. In particular, the automobile industry needs press lines consisting of a plurality of presses arranged one after the other and the associated transport system in order to fabricate, for example, easily delivered coils (rolls of flat metal ribbon) into complicated geometries, like fenders, vehicle doors, catalytic converter shells and much more.

In particular, fast running press systems are designed as mechanical presses, as described above.

The prior art has adopted the terminology of a wide range of different fields, so that it is necessary to explain some of the terms that are used and to give their best known synonyms with no claim to completeness.

A crank drive is, according to the invention, a drive that can transform rotational motion (of a motor) into a linear motion and also finds expression in the professional literature as an eccentric drive or slider crank drive or the like. As stated above, the main operational task of the crank drive is the conversion of a rotational motion into a translatory motion, during the course of which an eccentric shaft or hereinafter a crankshaft is used. The crankshaft has an eccentric journal or hereinafter a crank pin, which is mounted outside the axis of rotation of the crankshaft and on which a push rod—hereinafter referred to as the connecting rod—is usually arranged. The force flow of the drive can run from the smallest possible denominator of the crank drive, a crankshaft and a crank pin up to a ram by way of a plurality of stations, such as slider cranks, linkage mechanisms and the like, or also only one connecting rod.

Furthermore, the term press frame stands for the carrying frame of the press. Within the scope of the invention it includes all press frames in all possible configurations, such as press frames made of a plurality of single parts (top and bottom crosshead, lateral supports) as well as also press frames in window frame construction.

Direct drives and servo presses are distinguished by the fact that different speed gradients can be set through the use of, preferably, d.c. motors by way of a press stroke (top dead center—bottom dead center—top dead center). Even a reciprocating stroke operation is possible without the imminent risk of overloading the complicated gear drives, insofar as they are present.

DE 28 40 710 discloses a drive system that is provided for a forming machine and that shows a direct drive for a drive system of a press. In this case, the shaft output of the direct drive is additionally transmitted by a gearbox, before the driving force can be transmitted via the shaft to a crank disk and finally to a crank pin.

DE 102 60 127 A1 also discloses a direct drive that, on the one hand, is flanged externally to a shaft and that, on the other hand, delivers its driving force directly to the crankshaft without the aid of a variable speed transmission gear.

All of these disclosures have a serious disadvantage that the motor is disposed outside the carrying structures of the press or more specifically the press head. For this reason the motor is usually connected to the main drive shaft by means of a clutch or by directly mounting on the main drive shaft (flange, locking assembly or splined shaft).

The object of the present invention is to provide a press, in which the drive sided forces of the direct drive can be transmitted on the output drive side with a substantially smaller load on the crankshaft, and at the same time the overall rigidity of the drive train is significantly increased.

At the same time the necessary installation space of the press with a direct drive is significantly optimized and reduced; and simple measures for reducing the noise of the drive train can be implemented by encapsulating the motor that is installed in such a way that it is more or less adjacent to the crank drive.

This engineering object is achieved with a press according to the invention by means of the features disclosed in the characterizing part of claim 1.

The design according to the invention offers the following advantages. The press can be configured with a short overall length, a feature that is especially advantageous in servo presses in press lines for the manufacture of large car body parts. In order to keep the transport paths between the presses as short as possible, the presses have to stand close one behind the other. The shorter the distance, the quicker the transfer time. Large presses are usually designed with four pressure points (connecting rods or linkage mechanism) connections at the ram. The distances transversely and longitudinally between the pressure points or more specifically the connecting rods cannot be freely chosen, but rather must be chosen according to criteria with respect to the reduction of the ram deflection. Hence, the result may be, for example, a rod distance of 1,800 mm in the continuous flow direction (=axial direction of the main drive shaft) of the press. Therefore, the length of the press head in the continuous flow direction is determined by the distance of the connecting rod and the necessary design of the main bearings and the support structure.

In addition, the advantageous arrangement of the direct drive, in particular inside the necessary support structures of the press, offers a significantly more rigid drive system and, as a result, a reduction in the crankshaft torsion. If the crankshaft is driven from the outside as the main drive shaft, the torsion of the crankshaft has a negative impact on the whole drive system. The longer the distance between the motor and the crank pin or eccentric eye respectively, the softer the drive system will become and will lead to system oscillations, because the crankshaft acts like a torsion spring. Especially in this case there will be serious control problems in the event of an oscillating stroke. An additional problem is the tendency of the entire drive system to oscillate, a feature that in turn also causes problems for the support structures and the press frame respectively, so that the construction of a press becomes layout intensive. In the case of a unilateral drive with two connecting rods or two crank pins respectively on a shaft, the result is an angular offset, which causes the rod to occupy different stroke positions.

In this context the advantages of the invention also enhance the control quality of the system. Owing to the high rigidity of the drive system and the accurately adjustable torque and angular position control of the motor there are no measurable deviations between the two crank pins and, thus, at the connecting rods at a crankshaft. In addition, the process data can be gathered directly. Owing to the direct drive the press does not have any additional mechanical transfer members (for example, gear stages). The parameters, such as the speed, torque, angular position, which are measured at the motor, can be converted into ram speed, pressing force and ram position without errors. Falsified data due to frictional losses or torsion, tooth flank backlash, etc. are excellently eliminated.

Permanent magnet motors, especially at a high driving power, have a very high noise level. Owing to the installation into the press head, relatively simple measures can be applied to reduce in a simple way the noise emissions—for example, through abrasion of the press head at the top and bottom side.

The overall efficiency of the press is also significantly enhanced, because there is a significantly smaller amount of unused forces due to the torsion or the moment capacity in the bearings in the case of a floating mount of the motor. In a particular exemplary embodiment the stator of the direct drive can be supported in the press head and/or can be provided with a corresponding torque support. Therefore, in contrast to a conventional direct drive, the motor does not have its own mount; and the mounting of the rotor inside the stator is also taken over by the main bearing of the crankshaft. This feature totally eliminates any additional losses that might occur.

In an especially preferred exemplary embodiment, in particular in the case of large presses of high tonnage, the direct drive is put on the carrying part of the crankshaft. That is, it is located between the main bearings of the mechanical drive that absorb the pressing force. Preferably the motor is then located between the main carrying support structure (at least two press frames of the press) and concentrically to the main drive shaft (crankshaft). The connecting rods or in the case of articulated drives the pivotal levers that lead to the connecting rod, can be situated either on the right and left of the motor and, thus, between the motor and the main bearings (support structure of the press head) or unilaterally between the motor and one of the main bearings.

Other advantageous measures and embodiments of the subject matter of the invention are apparent from the dependent claims and the following description with the drawings.

Referring to the drawings:

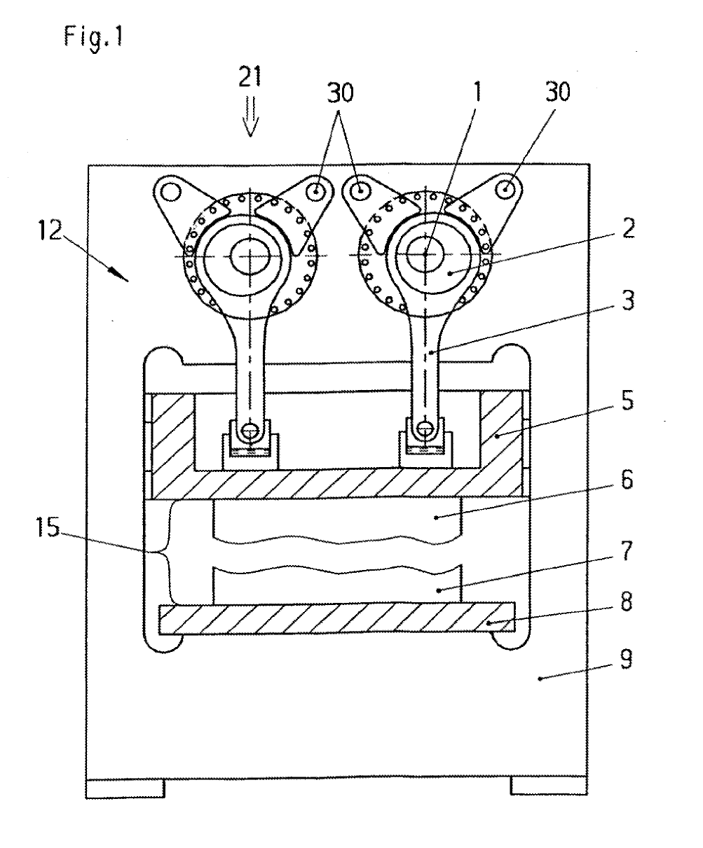

FIG. 1 is a schematic view of a mechanical press with a press frame and a press table, where in the upper region of the press, in the head region, the drive system, consisting of two crank drives, each of which comprising a crankshaft, a crank pin and a connecting rod, which is operatively connected to a ram.

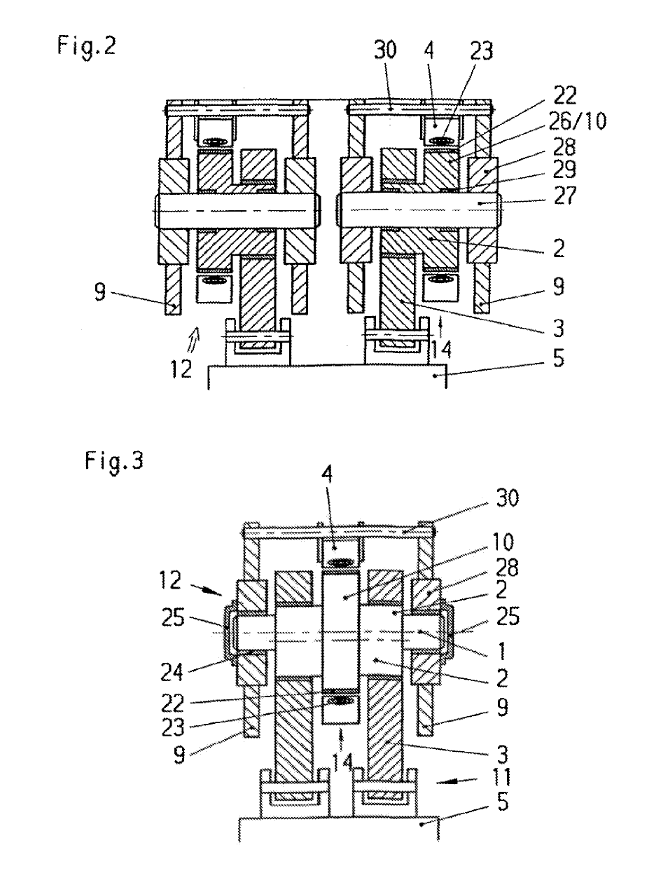

FIG. 2 is a side view of another embodiment from FIG. 1, where in this case, too, two connecting rods are mounted on a ram, so that they are driven separately from each other by a crank drive, wherein the crankshaft is replaced by a thru axle and carries an eccentric wheel with a motor, which is mounted directly thereon.

FIG. 3 is a side view of another exemplary embodiment of the press drive from FIG. 2, where the motor is mounted on a crankshaft between two crank pins.

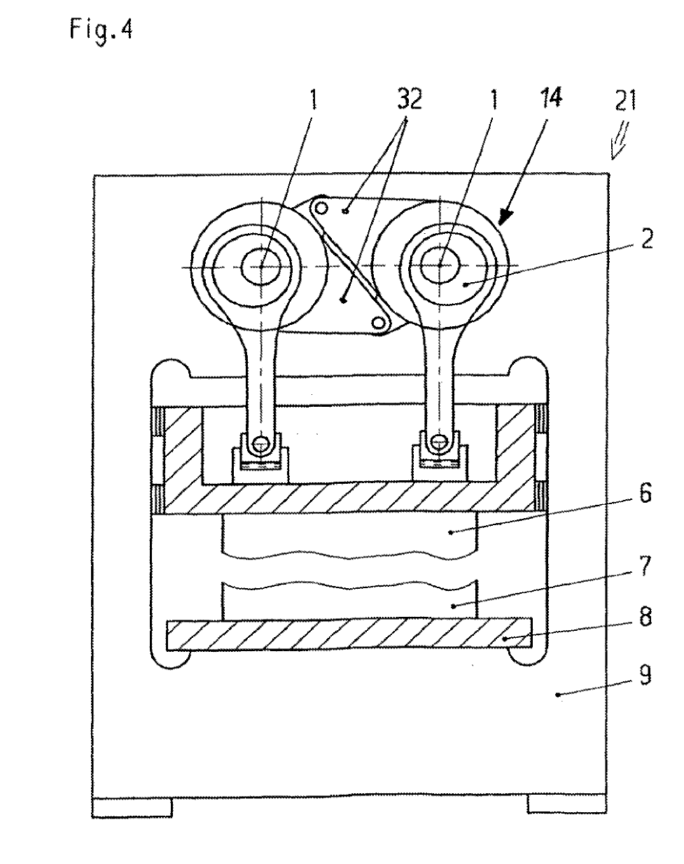

FIG. 4 is a schematic view of a preferred reaction compensation of two driven crankshafts with the motor mounted on the crankshaft.

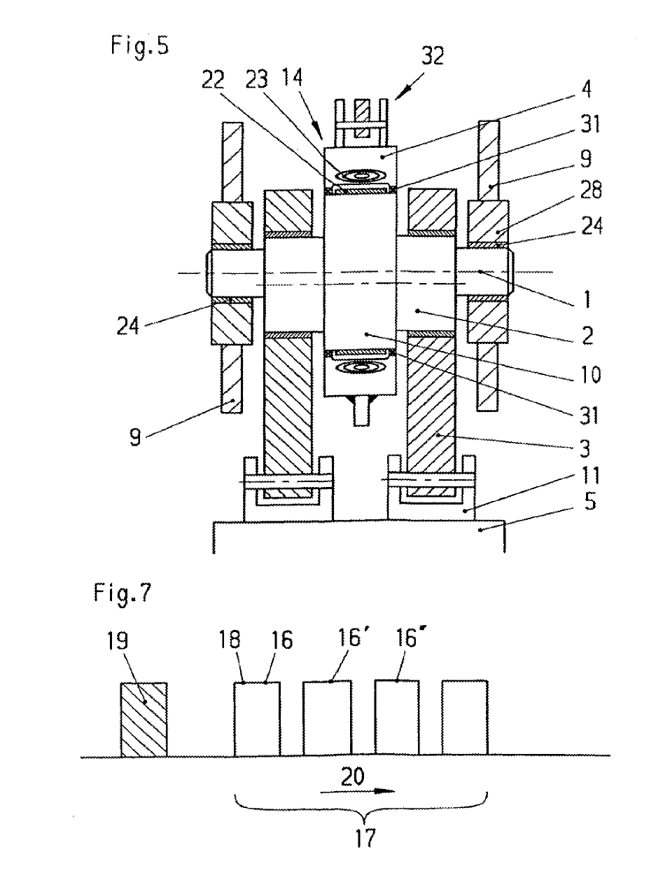

FIG. 5 is a side view from FIG. 4 to illustrate the mounting of the motor on the crankshaft.

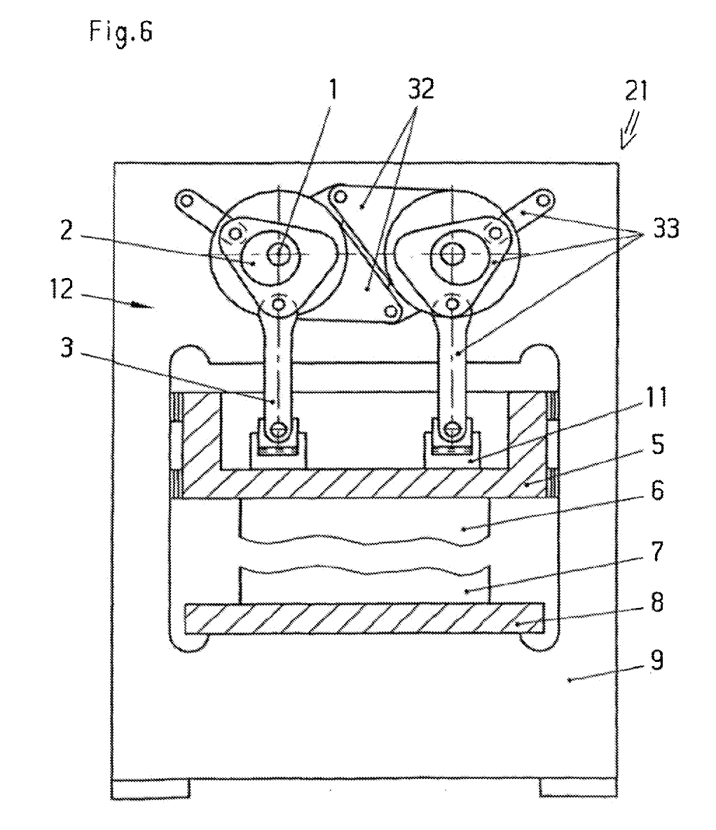

FIG. 6 shows another preferred embodiment of the crank drive with an articulated drive; and

FIG. 7 shows a possible arrangement of the inventive press in a press line.

According to FIG. 1, the press 21 consists of at least one press frame 9, a table 8, which is mounted in said frame, and a ram 5, which is driven by means of at least one crank drive 12. Preferably this press 21 is used for integrating work tools 15 or for producing workpieces (not illustrated) by means of at least one production method in a work tool 15, wherein the work tool consists of a tool upper part 6 at the ram 5 and a tool lower part 7 at the press table 8. At least one crankshaft 1 with at least one crank pin 2 and at least one connecting rod 3 is provided as the crank drive 12; and at least one direct drive, directly driving the crankshaft 1, is provided as the motor 14 for the drive of the crankshaft 1. The crank drive 12—also called the eccentric drive—can have, instead of the connecting rod 3 or between the connecting rod and the crank pin an articulated drive or a slider crank or similar intermediate devices, which are usually used for adjusting the stroke length, for safety reasons or for adjusting the sinusoid curve of the path of motion of the ram.

In order to drive a toggle joint drive, an articulated drive, an additional crank drive or a combination thereof, the crank drive 12 is arranged, in particular, so as to be operatively connected to the same; and they in turn are operatively connected to the ram 5 on the output drive side.

According to FIG. 2, the motor 14 is mounted preferably more or less adjacent to a crank pin 2 on the crankshaft 1. A so-called crank disk can be integrated in or at the motor as a function of the design variant and the defined position. In this case the stator of the motor is configured preferably in such a way that it takes over the function of the crank disk and guides the crank pin outside the central axis of the crankshaft 1. It is clear from FIGS. 2 and 3 that the rotor 10 of the motor 14 can be mounted on the crankshaft. According to FIG. 2, a thru axle 27 guides a crank drive 12, which is mounted on the thru axle 27 by means of bearings 29. In this embodiment preferably only the eccentric wheel 26, which forms the crank pin 2 and the rotor 10 as a one piece machine element, rotates. At this point the maximum minimization of the moved mass for a press 21 is already evident. Working on the basis of the design, the two bearings 29 between the thru axle 27 and the eccentric wheel 26, which is mounted in a rotatable manner on the thru axle 27, can also be configured as a continuous main bearing 29. A mount 30, which is connected to the top of the press frame 9, is provided for torque compensation and/or for mounting the motor 14. The motor 14 usually has as the direct drive a stator 4 with a driving coil 23 and, attached thereto, a rotor 10 with permanent magnets 23 and would then be constructed as a permanent magnet motor.

According to FIG. 3, at least one motor 14 is arranged between the crank pins 2 when there are at least two crank pins 2 on a crankshaft 1. If there are a plurality of motors or crank pins, a symmetrical arrangement is especially preferred. Thus, it can be provided that in the event of a plurality of motors 14 and a plurality of crank pins 2 at least two motors 14 are arranged symmetrically to one of the central axes of the press frame and/or to one of the central axes of the ram 5 and/or to the longitudinal center point of the crankshaft 1 and/or for arranging the crank pins 2 on the crankshaft 1. It would also be advantageous if the rotor 10 of the motor 14 and the crankshaft 1 and/or the crank pin 2 consisted of a one piece machine element. In addition, a length adjustment for the stroke of the ram 5 can also be arranged in the crank drive 12. An overload safety device 11 protects the press against major damage in the event of a malfunction and uncouples the connecting rods 3 from the ram 5 in the case of damage.

Preferably the stator 4 of the motor 14 is provided with a mount 30 for absorbing the reaction torques more or less inside the press frame 9 and/or the head region above the ram 5, which moves up and down. As an alternative, the stator 4 of the motor 14 can be arranged relative to the crankshaft 1 and/or the rotor 10 without a mount.

In FIGS. 4 and 5 the stator 4 is guided coaxially to the crankshaft 1 and/or the rotor by way of the bearings of the crankshaft. In this case the stator 4 of a motor 14 can be mounted on a bearing 31 on the rotor 10; and it appears to be logical to provide a torque support 32 with connection to the press frame 9 to compensate for any torque occurring at the stator 4. It is especially clear from FIG. 4 that when there are two crankshafts 1, each stator 4 of a motor 14 is mounted on a bearing 31 at the rotor 10; and in order to compensate for any torque occurring at the stators 4, a torque support 32 with connection to the motor 14 is arranged on the adjacent crankshaft 1 and enables a mutual support of the torques. This feature offers, in particular, advantages with respect to the transmission of oscillations to the press frame 9.

As stated, the motor 14 and the crank drive 12 can be arranged inside a support structure formed by the press frame 9. Given such press frames, it is possible to generate, in particular, pressing forces exceeding 200 tons, preferably exceeding 500 tons, and even more preferably exceeding 800 tons. Presses of this type can produce a ram 5 stroke of over 300 m, preferably over 600 mm, even more preferably of over 900 mm in length. Preferably the press 21 is used for a production method that includes at a minimum the primary shaping, separating, joining, coating and/or forming, in particular the metal forming process.

FIG. 6 shows, instead of a crank drive 12, which has, instead of the connecting rods 3, an articulated drive 33.

FIG. 7 shows the use of the press 21 as a head press 18 of a press line 17, as a training press for work tools 15 of a press line 17 and/or as at least a transfer press 16 in a transfer press line 17 and/or as a prepress 19 in the manufacturing direction 20 upstream of a transfer press line 17.

Preferably the bearings 24 of the crankshaft 1 are mounted in bearing brackets, which can be removed from the press frame 9, so that an opening having an installation diameter can be opened in the press frame. Preferably the diameter of said opening is equal to or larger than the diameter of the rotor on the shaft or corresponds to the largest diameter on the shaft. During installation it may be helpful to arrange a crankshaft 1, which is divided at least once in the longitudinal axis, in the press that has, for example, a flange connection, removable bearing pins or a shaft/hub connection. It is especially preferred that the rotor 10 be mounted in an undetachable manner on the crankshaft 1. For this purpose it is possible to use a shrink fit, a welded joint, a soldered joint, a friction welded joint, an adhesively cemented joint and/or any other inseparable joining connection in order to connect the rotor 12 to the crankshaft 1.

A preferred embodiment of the rotor 10 would be grooves and/or depressions for accommodating the permanent magnets 22, which are not installed until after the one piece machine element has been finished.

List of Reference Numerals:

| | |
|---|---|
| 1. | crankshaft |
| 2. | crank pin |
| 3. | connecting rod |
| 4. | stator |
| 5. | ram |
| 6. | tool upper part |
| 7. | tool lower part |
| 8. | table |
| 9. | press frame |
| 10. | rotor |
| 11. | overload safety device |
| 12. | crank drive |
| 13. | |
| 14. | motor |
| 15. | tool |
| 16. | transfer press |
| 17. | transfer press line |
| 18. | head press |
| 19. | prepress |
| 20. | manufacturing direction |
| 21. | press |
| 22. | permanent magnet |
| 23. | driving coil |
| 24. | bearing in 9 |
| 25. | bearing cover |
| 26. | eccentric wheel |
| 27. | thru axle |
| 28. | installation opening |
| 29. | bearing for 26 |
| 30. | mount |
| 31. | motor mount |
| 32. | torque support |
| 33. | articulated drive |

1. A press comprising at least one press frame, a table, which is mounted in said frame, and a ram, which is driven by means of at least one crank drive, for integrating work tools or for producing workpieces by means of at least one production method in a work tool, wherein a tool upper part is arranged at the ram and a tool lower part is arranged at the press table, wherein at least one crankshaft with at least one crank pin and at least one connecting rod is provided as the crank drive; and wherein at least one direct drive, directly driving the crankshaft, is provided as a motor for the drive of the crankshaft, wherein the motor is arranged substantially adjacent to a crank pin on the crankshaft.

2. The press, as claimed in claim 1, wherein when there are at least two crank pins on a crankshaft, at least one motor is arranged between the crank pins.

3. The press, as claimed in claim 1, wherein a rotor of the motor is mounted on the crankshaft.

4. The press, as claimed in claim 2, wherein when there are a plurality of motors or a plurality of crank pins, at least two motors are arranged symmetrically to one of the central axes of the press frame and/or to one of the central axes of the ram and/or to the longitudinal center point of the crankshaft and/or for arranging the crank pins on the crankshaft.

5. The press, as claimed in claim 3, wherein the rotor of the motor and the crankshaft and/or the crank pin comprise a one piece machine element.

6. The press, as claimed in claim 1, wherein a length adjustment for a stroke of the ram is arranged in the crank drive.

7. The press, as claimed in claim 1, wherein a toggle joint drive and/or an articulated drive is (are) arranged between the crank drive and the ram.

8. The press, as claimed in claim 1, wherein in order to drive a toggle joint drive, an articulated drive, an additional crank drive or a combination thereof, the crank drive is operatively connected to the same, so that they in turn are operatively connected to the ram on an output drive side.

9. The press, as claimed in claim 1, wherein a permanent magnet motor is provided as the motor.

10. The press, as claimed in claim 1, wherein a stator of the motor is provided with a mount for absorbing reaction torques substantially inside the press frame and/or the head region (above the ram, which moves up and down).

11. The press, as claimed in claim 3, wherein a stator of the motor is arranged relative to the crankshaft and/or the rotor without a mount.

12. The press, as claimed in claim 10, wherein the stator is arranged so as to be guided coaxially to the crankshaft and/or a rotor by way of the bearings of the crankshaft.

13. The press, as claimed in claim 3, wherein a stator of the motor is arranged on a bearing at the rotor; and a torque support with connection to the press frame is provided to compensate for any torque occurring at the strator.

14. The press, as claimed in claim 3, wherein when there are two crankshafts, each stator is arranged on a bearing at the rotor; and in order to compensate for any torque occurring at the stators, a torque support with connection to the motor is arranged on an adjacent crankshaft.

15. The press, as claimed in claim 1, wherein the motor and the crank drive are arranged inside a support structure formed by the press frame.

16. The press, as claimed in claim 1, characterized by a pressing force exceeding 200 tons, preferably exceeding 500 tons, and even more preferably exceeding 800 tons.

17. The press, as claimed in claim 1, characterized by a ram stroke of over 300 mm, preferably over 600 mm, even more preferably of over 900 mm.

18. A method comprising:
providing the press of claim 1; and
using the press for a production method that includes at a minimum the primary shaping, separating, joining, coating and/or forming, in particular a metal forming process.

19. A method comprising:
providing the press of claim 1; and
using the press as a head press or as a training press for work tools of a press line and/or as at least a transfer press in a transfer press line and/or as a prepress in the manufacturing direction upstream of a transfer press line.
